(19) United States
(12) Patent Application Publication
(10) Pub. No.: US 2022/0207568 A1
(43) Pub. Date: Jun. 30, 2022

(54) INFORMATION PROCESSING DEVICE, INFORMATION PROCESSING METHOD, AND PROGRAM

(71) Applicant: TOYOTA JIDOSHA KABUSHIKI KAISHA, Toyota-shi (JP)

(72) Inventors: Minoru FUJII, Miyoshi-shi (JP); Shunji MIYAHARA, Okazaki-shi (JP); Hiroaki YOKOYAMA, Toyohashi-shi (JP)

(73) Assignee: TOYOTA JIDOSHA KABUSHIKI KAISHA, Toyota-shi (JP)

(21) Appl. No.: 17/500,356

(22) Filed: Oct. 13, 2021

(30) Foreign Application Priority Data
Dec. 25, 2020 (JP) 2020-217068

(51) Int. Cl. G06Q 30/02; G06Q 30/06; G06N 20/00

(52) U.S. Cl. CPC G06Q 30/0269; G06N 20/00; G06Q 30/0641; G06Q 30/0631

(57) ABSTRACT

An information processing method including: inputting purchase history information of a second user to a prediction model, the second user being a prediction target, the prediction model having learned with learning data, the learning data including purchase history information of a first user as input data and information regarding a first product as a label, the first user being a learning target, the learning data being learning data regarding a plurality of the first users; acquiring first information regarding one or a plurality of products having a possibility to be purchased by the second user, based on an output from the prediction model in response to the input; and outputting the first information.

### CROSS-REFERENCE TO RELATED APPLICATION

This application claims priority to Japanese Patent Application No. 2020-217068 filed on Dec. 25, 2020, incorporated herein by reference in its entirety.

### BACKGROUND

### 1. Technical Field

The present disclosure relates to an information processing method, an information processing device, and a program.

### 2. Description of Related Art

A technique for estimating the probability that a customer will purchase a product based on information regarding the product purchased by the customer is disclosed (for example, Japanese Unexamined Patent Application Publication No. 2015-095120 (JP 2015-095120 A)).

### SUMMARY

One of the aspects of the disclosure is to provide an information processing method, an information processing device, and a program that can more accurately predict a product that a customer is likely to purchase.

An aspect of the present disclosure is an information processing method including:

inputting purchase history information of a second user to a prediction model, the second user being a prediction target, the prediction model having learned with learning data, the learning data including purchase history information of a first user as input data and information regarding a first product as a label, the first user being a learning target, the first product being last purchased by the first user, the learning data being learning data regarding a plurality of the first users, the purchase history information of the first user including information regarding each of N (N: a positive integer of 2 or more) second products from a product purchased directly preceding the first product to a product purchased N products before the first product, and the purchase history information of the second user including information regarding each of N third products including purchased products from a product currently owned by the second user to a product purchased N−1 products before the product that is currently owned;

acquiring first information regarding one or a plurality of products having a possibility to be purchased by the second user, based on an output from the prediction model in response to the input; and

outputting the first information.

Another aspect of the present disclosure is an information processing device including a control unit that executes:

input of purchase history information of a second user to a prediction model, the second user being a prediction target, the prediction model having learned with learning data, the learning data including purchase history information of a first user as input data and information regarding a first product as a label, the first user being a learning target, the first product being last purchased by the first user, the learning data being learning data regarding a plurality of the first users, the purchase history information of the first user including information regarding each of N (N: a positive integer of 2 or more) second products from a product purchased directly preceding the first product to a product purchased N products before the first product, and the purchase history information of the second user including information regarding each of N third products including purchased products from a product currently owned by the second user to a product purchased N−1 products before the product that is currently owned;

acquisition of first information regarding one or a plurality of products having a possibility to be purchased by the second user, based on an output from the prediction model in response to the input; and output of the first information.

One of the other aspects of the present disclosure is a program for causing a computer to execute the information processing method that is one of the aspects of the present disclosure, or a computer-readable non-temporary recording medium in which the program is recorded.

According to the present disclosure, it is possible to more accurately predict the product that a customer is likely to purchase.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an example of a diagram showing a flow of prediction of purchased products in a purchase prediction system according to the first embodiment;

FIG. 2 is a diagram showing an example of a hardware configuration of an information processing device;

FIG. 3 is a diagram showing an example of a functional configuration of the information processing device;

FIG. 4 is an example of purchase history information;

FIG. 5 is an example of a correspondence table between a value type and a vehicle;

FIG. 6 is a diagram showing an example of learning in a purchase prediction model;

FIG. 7 is a diagram showing an example of a prediction process of the purchase prediction model;

FIG. 8 is a diagram showing an example of a determination process of a purchased product based on output data of the purchase prediction model;

FIG. 9 is an example of a flowchart of a learning process of the purchase prediction model in the purchase prediction system; and

FIG. 10 is an example of a flowchart of the prediction process in the purchase prediction system.

### DETAILED DESCRIPTION OF EMBODIMENTS

One aspect of the present disclosure provides an information processing method. The information processing method is executed by a computer such as a server, for example. The information processing method is a method of predicting one or a plurality of products that a user may purchase next by using a prediction model. The products are, for example, durable product such as private cars, home appliances, and furniture.

The prediction model is a machine learning model constructed by a predetermined algorithm. The prediction model is learnt by a plurality of learning data. The algorithm and learning method of the prediction model are not limited to a predetermined algorithm and a predetermined learning method.

The learning data of the prediction model includes input data and labels. The input data of the learning data is purchase history information of a first user including information regarding each of the N second products purchased from a purchased product directly preceding a first product that is last purchased by the first user up to the second product purchased N products before the first product. The label of the prediction model is information regarding the first product that the first user last purchased. The plurality of learning data is data about a plurality of first users. That is, the first user is the user who is the target of the learning data.

The information processing method includes inputting in the prediction model, purchase history information of a second user including information regarding each of the N third products including a product purchased N−1 number of products before from the product currently owned by the second user that is the prediction target, acquiring and outputting first information regarding one or a plurality of products that the second user might purchase, based on the output in response to the input from the prediction model.

The information regarding the successive products that the second user who is the prediction target has purchased so far reflects the value of the second user in terms of purchasing of the product. Thus, according to one of the aspects of the present disclosure, since the information regarding the successive products that the second user that is the prediction target has purchased so far is used, in accordance with the values of the second user, it is possible to more accurately predict the products that the second user may purchase next.

To more accurately predict the product that the second user who is the prediction target may purchase next means that it is more likely that the second user will take some kind of action regarding the predicted product when a sales promotion activity regarding the predicted product is performed, for example. The actions taken by the second user regarding the predicted product include, for example, searching for the product, going to a store to see the product, and purchasing the product.

In one aspect of the present disclosure, the input data of the learning data may further include a family structure of the first user at the time of purchase of the first product last purchased by the first user. In this case, in the input to the prediction model, the family structure of the current second user may be further input. Alternatively, the input data of the learning data may further include the family structure of the first user at the time of purchase of each of the N second products includes in the purchase history of the first user. In the input to the prediction model, the family structure of the second user at the time of purchase of each of the N third products included in the purchase history of the second user.

Since the product that is durable is often used with the family, the family structure at the time of purchase of each product affects the values of the purchase of the product. In addition, since the family structure may change over time, there is a possibility that values also change as the family structure changes. Therefore, by using the family structure as one of the input data of the prediction model, in accordance with the values of the second user that change with the change of the family structure, the product that the second user may purchase can be more accurately predicted.

In one aspect of the present disclosure, the input data of the learning data further includes a holding period of each of the N second products included in the purchase history of the first user, and in the input to the prediction model, a holding period of each of the N third products included in the purchase history of the second user. Alternatively, the input data of the learning data may further include attributes of the first user, and attributes of the second user may be further input in the input to the prediction model. The user's attributes are, for example, at least one of the age, gender, year of birth, occupation, and the like.

Each of the holding period of the product and the attributes of the user is one of the information that influences the values for the purchase of the product. The holding period is, for example, a period from a purchase period to a disposal period. For example, the times and the age of the user vary depending on the purchase period, and along with these changes, the user's values may change. Further, for example, men and women may have different tastes, and there are characteristics of values according to the attributes of the user. Therefore, by using the holding period of the product and the attributes of the user serving as the input data of the prediction model, in accordance with the values of the second user that is the prediction target, the product that the second user may purchase can be more accurately predicted.

In one aspect of the present disclosure, the input data of the learning data may further include N pieces of value information of the first user indicating the values regarding purchase, regarding each of the N second products included in the purchase history of the first user. In this case, in one aspect of the present disclosure, in the input to the prediction model, N pieces of value information of the second product, regarding each of the N third products includes in the purchase history of the second user may be further input. The value information of the first user and the value information of the second user are one of the subjective information of the first user and the second user. The value information of the first user and the value information of the second user may be, for example, response data of a questionnaire of the first user and the second user regarding the values regarding purchasing the product, respectively. Therefore, by using the value information of the user as one of the input data of the prediction model, in accordance with the values of the second user that is the prediction target, the product that the second user may purchase can be more accurately predicted.

In addition, one aspect of the present disclosure may further include storing in a storage unit, an association of each predetermined number of types that categorizes the values of the user regarding purchasing the product, and one or a plurality of products that the user is likely to purchase categorized to each of the predetermined number of types. In this case, the value information of the first user that is N learning targets may be N types of the first user that are categorized based on the response data of the questionnaire of the first user regarding each of the N second products included in the purchase history of the first user. Further, labels of the learning data may be the type of the first user that is categorized based on the response data of the questionnaire of the first user regarding the purchase of the first product serving as information regarding the first product included in the purchase history of the first user. In this case, in one aspect of the present disclosure, N types of the second user that is categorized based on the response data of the questionnaire of the second user regarding each of the N third products included in the purchase history of the second user may be acquired as N pieces of value information of the second user, and may be further input to the prediction model. Further, in one aspect of the present disclosure, based on the output with respect to the input to the prediction model, a first type into which the current values of the second user regarding purchasing the product is predicted to be categorized may be acquired, and information regarding one or more products associated with the first type in the storage unit may be acquired as the first information.

The products that the second user who is the prediction target may purchase next include all the products existing in the world, and the number is enormous. In addition, since the values of the user regarding purchasing products differ from user to user, the number is enormous. Thus, by categorizing the user's values regarding purchasing into the predetermined number of types and associating the products that are likely to be purchased with each type, the amount of information used as the input and output of the prediction model is scaled down, and a processing load regarding the prediction by the prediction model can be reduced. Further, in this case, the output of the prediction model is the probability that the current values of the second user regarding purchasing the product are categorized for each predetermined number of types, and the type with the highest probability may be acquired as first type.

In one aspect of the present disclosure, the prediction model may learn the learning data. As a result, the prediction model can be updated as appropriate.

As another aspect of the present disclosure, an information processing device that executes the above-mentioned information processing method, a program for causing a computer to execute the above-mentioned information processing method, and a non-temporary computer readable recording medium that stores the program can also be specified.

Hereinafter, embodiments of the present disclosure will be described with reference to the drawings. The configurations of the following embodiments are illustrative, and the present disclosure is not limited to the configurations of the embodiments.

### First Embodiment

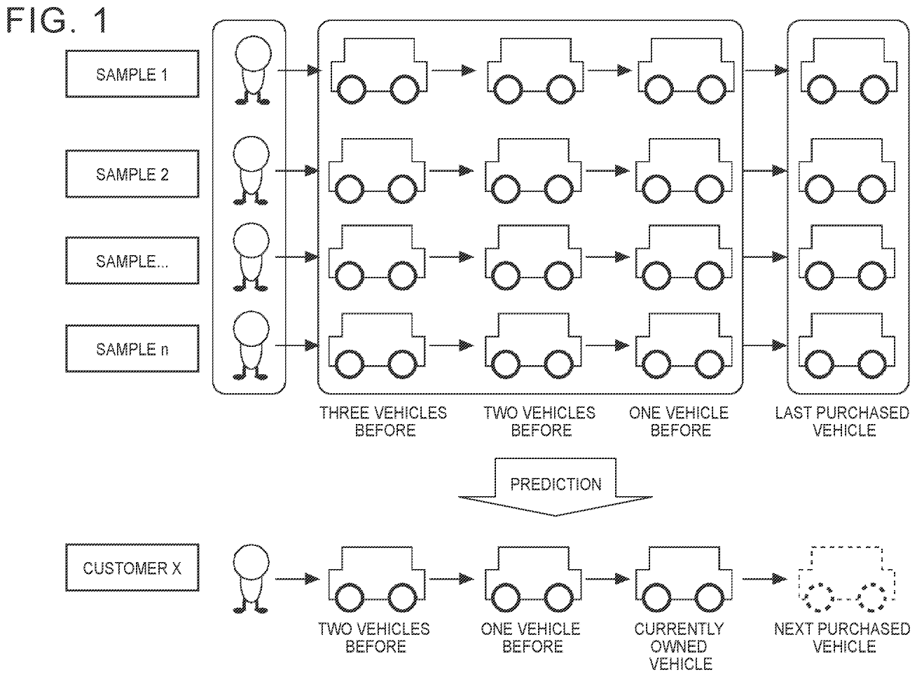

FIG. 1 is an example of a diagram showing a flow of prediction of purchased products in a purchase prediction system 100 according to the first embodiment. The purchase prediction system 100 is a system that predicts the next product to be purchased by the user from the user's product purchase history. In the first embodiment, the product to be predicted is a private car. In the first embodiment, the vehicle is identified by the vehicle name. The products to be predicted by the purchase prediction system 100 are not limited to private cars, but also include household electric appliances and durable product such as furniture. Further, the products that are the prediction target of the purchase prediction system 100 are not limited to those for personal use, and may include durable product used in organizations, companies, factories, and facilities.

The purchase prediction system 100 uses the purchase prediction model for predicting purchased products. The purchase prediction model learns the relationship between information of the successive vehicles purchased by a person who has purchased a vehicle and information regarding the last purchased vehicle, which are collected by an Internet survey, for example. Based on the output acquired by inputting information regarding successive vehicles purchased by the predicted target person into the purchase prediction model, the vehicle that the prediction target person may purchase next is predicted. Hereinafter, a user who is the acquisition source of the data used for learning of the purchase prediction model is referred to as a learning target user. Further, a user who is a target of prediction using the purchase prediction model is referred to as a prediction target user. The learning target user is an example of a “first user”. The prediction target user is an example of a “second user”. The purchase prediction model is an example of a “prediction model”.

In the first embodiment, in the learning of the purchase prediction model, the relationship between information regarding three vehicles that are from the vehicle purchased three vehicles to the vehicle purchased one vehicle before the vehicle last purchased by the learning target user, and information regarding the vehicle last purchased is learned. In the prediction using the purchase prediction model, information regarding three vehicles from the vehicle purchased two vehicles before by the prediction target user to the vehicle currently owned is input to the purchase prediction model, and based on the output of the purchase prediction model, the next vehicle that may be purchased is determined.

The user's vehicle purchase history reflects the user's values regarding the purchase of the vehicle. Therefore, according to the first embodiment, it is possible to accurately predict the vehicle that may be purchased next from the purchase history of the user's vehicle.

In addition, there is information that influences the user's values regarding the purchase of the vehicle in addition to the information regarding the successive purchased vehicles. In addition, the user's values include the unchangeable values that the user originally has and the values that change due to the influence of the environment and the like. Information that influences the unchangeable values that the user originally has includes, for example, user attribute information, childhood hobbies, and original experience. The user attribute information includes, for example, year of birth, gender, occupation, and the like. However, the user's attribute information that affects the user's unchangeable values is not limited to this.

Information that affects the user's changing values includes, for example, information that changes over time, such as age, family structure, and living environment. However, the information that influences the user's changing values is not limited to these.

That is, the information that affects the user's values regarding purchasing the vehicle includes, for example, information such as the user's attribute information, hobbies, original experience, family structure at the time of purchase, age at the time of purchase, and living environment at the time of purchase, in addition to the information regarding the successive purchased. In the first embodiment, learning of the purchase prediction model and the prediction by the purchase prediction model is performed by using the above information as well, and the accuracy of the prediction of the vehicle that the user may purchase next is improved.

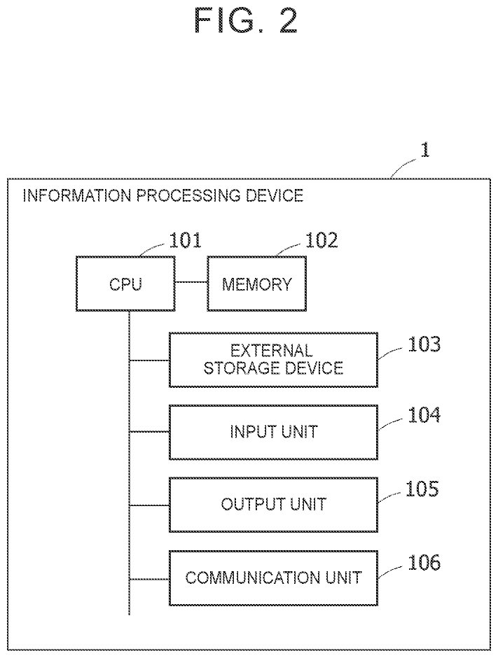

FIG. 2 is a diagram showing an example of a hardware configuration of an information processing device 1. The information processing device 1 is a device of the purchase prediction system 100 that predicts the purchased products. The information processing device 1 is, for example, a dedicated computer such as a server, or a general-purpose computer such as a personal computer (PC). The information processing device 1 includes a central processing unit (CPU) 101, a memory 102, an external storage device 103, an input unit 104, an output unit 105, and a communication unit 106 as hardware configurations. The memory 102 and the external storage device 103 are computer-readable recording media.

The external storage device 103 stores various programs and data used by the CPU 101 when the CPU 101 executes each program. The external storage device 103 is, for example, an erasable programmable ROM (EPROM) or a hard disk drive (HDD). The program stored in the external storage device 103 includes, for example, an operating system (OS), a purchased product prediction system, and various other application programs. The purchased product prediction program is a program that predicts the next vehicle to be purchased by the user from the user's vehicle purchase history.

The memory 102 is a storage device that provides the CPU 101 with a storage area and a work area for loading the program stored in the external storage device 103, and that is used as a buffer. The memory 102 includes, for example, a semiconductor memory such as a read-only memory (ROM) or a random access memory (RAM).

The CPU 101 executes various processes by loading the OS and various application programs stored in the external storage device 103 into the memory 102 and executing the OS and the various application programs. The number of CPUs 101 is not limited to one, and a plurality of the CPUs 101 may be provided. The CPU 101 is an example of a “control unit” of the “information processing device”.

The input unit 104 is, for example, an input device such as a keyboard or a pointing device such as a mouse. The signal input from the input unit 104 is output to the CPU 101. The output unit 105 is an output device such as a display or a printer. The output unit 105 outputs information in response to the input of a signal from the CPU 101. The input unit 104 and the output unit 105 may be an audio input device and an output device, respectively.

The communication unit 106 is an interface for inputting and outputting information to and from the network. The communication unit 106 may be an interface that connects to a wired network or an interface that connects to a wireless network. The communication unit 106 is, for example, a network interface card (NIC), a wireless circuit, or the like. Note that, the hardware configuration of the information processing device 1 is not limited to that shown in FIG. 2.

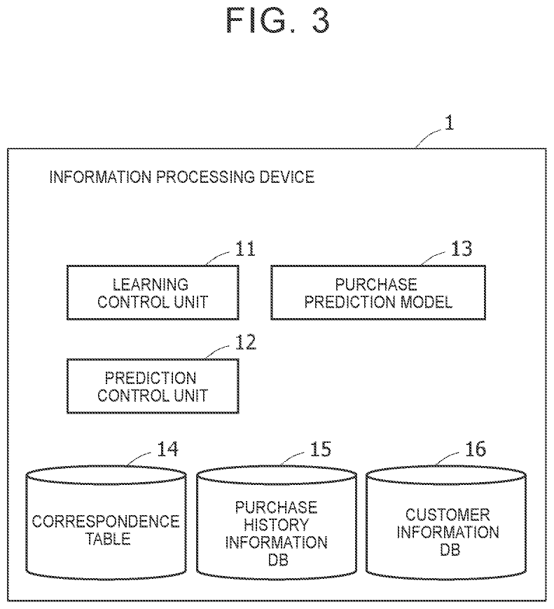

FIG. 3 is a diagram showing an example of the functional configuration of the information processing device 1. The information processing device 1 includes as functional components, a learning control unit 11, a prediction control unit 12, a purchase prediction model 13, a correspondence table 14, a purchase history information DB 15, and a customer information DB 16. These functional components are achieved, for example, by the CPU 101 of the information processing device 1 executing a product purchase prediction program.

The learning control unit 11 creates and updates the purchase prediction model 13. For both the creation and updating of the purchase prediction model 13, the learning control unit 11 acquires the learning data and inputs the learning data to the purchase prediction model 13 for learning. The learning data is acquired from the purchase history information DB 15 and the customer information DB 16. Details the information held in the learning data, the purchase history information DB 15, and the customer information DB 16 will be described later.

The learning control unit 11 updates the purchase prediction model 13 at a predetermined timing. The update timing of the purchase prediction model 13 is, for example, a predetermined cycle, a predetermined event occurrence, a learning instruction input, or the like. The update cycle of the purchase prediction model 13 is set to, for example, an arbitrary period of one month to one year. The details of the learning of the purchase prediction model 13 will be described later.

For example, when the prediction start instruction is input, the prediction control unit 12 starts predicting the purchased product of the prediction target user. The prediction start instruction is input from a user terminal, for example, through the input unit 104 or via the network. For example, the identification information of the prediction target user or the data of the prediction target user is input together with the prediction start instruction. When the prediction target user identification information is input together with the prediction start instruction, the prediction control unit 12 acquires data corresponding to the prediction target user identification information from, for example, the purchase history information DB 15 and the customer information DB 16. The data acquired here is, for example, user attribute information of the prediction target, information regarding the vehicles from the vehicle purchased three vehicles before to the vehicle currently owned, and response data of a questionnaire on the purchase of each vehicle.

The prediction control unit 12 generates input data to the purchase prediction model 13 from the data of the prediction target user. The prediction control unit 12 performs categorization based on the response data of the questionnaire regarding the purchase of the vehicle of the prediction target user, and acquires the value type of the prediction target user regarding the purchase of each of the purchased vehicles up to three vehicles before. The input data to the purchase prediction model 13 is data that scores, for example, user attribute information, and information regarding the vehicle, purchase value type, holding period, and family structure at the time of purchase for each purchased vehicle up to two vehicles before.

The prediction control unit 12 inputs the input data of the prediction target user into the purchase prediction model 13 and acquires the output of the purchase prediction model 13. Based on the output of the purchase prediction model 13, the prediction control unit 12 determines a vehicle that the prediction target user may purchase next. The prediction control unit 12 outputs from the output unit 105 or transmits to the user terminal via the network, information regarding the vehicle that the prediction target user may purchase, in accordance with an input path of the prediction start instruction. Details of the prediction process of purchased product will be described later.

The purchase prediction model 13 is a learned model. When an input value is given, the purchase prediction model 13 performs a predetermined calculation and outputs the calculation result as an output value. The purchase prediction model 13 is a machine learning model that performs supervised learning of neural networks, logistic regression, trees, Bayes, time series, and the like. However, the purchase prediction model 13 is not limited to a specific machine learning model. Further, the learning method of the purchase prediction model 13 is not limited to a specific learning method.

For example, when the purchase prediction model 13 has a neural network, the processing is as follows. A parameter sequence {xi, i=1, 2, . . . , N} is input to the purchase prediction model 13. The purchase prediction model 13 executes a convolution process and a pooling process. In the convolution process, the product-sum calculation is performed in the input parameter sequence by the weighting coefficient {wi, j, l, (where j is a value from 1 to the element number M to be convolved, and l is a value from 1 to the layer number L). The pooling process is a process for thinning out a part from the activation function that determines the result of the convolution process and the determination result of the activation function for the convolution process. The purchase prediction model 13 repeatedly executes the above process over a plurality of layers L from the input layer in which the parameter string is input to the highest-level fully connected layer, and outputs output parameters (or output parameter strings) {yk, k=1, . . . , P} in the final stage fully connected layer. In learning with a supervised model, the output parameter (output value) and the correct answer data (label) are compared, and an error is calculated. The error is reverse-propagated from the highest-level fully connected layer to the input layer over a plurality of layers of the neural network, and the weighting coefficient is adjusted. Further, when a new parameter string is input to the learnt purchase prediction model, the purchase prediction model 13 outputs output parameters for the input parameter string.

Correspondence table 14 is a table that holds the correspondence between a predetermined number of value types and the vehicle names of vehicles that are likely to be purchased for each value type. The values regarding the purchase of successive purchased vehicles of the learning target user and the prediction target user are categorized into any of a predetermined number of value types defined in the correspondence table 14. The correspondence table 14 is stored in the external storage device 103. Details of the correspondence table 14 will be described later.

The purchase history information DB 15 and the customer information DB 16 are each created in the storage area of the external storage device 103. The purchase history information DB 15 stores, for example, questionnaire response data regarding vehicles that each user has purchased in the past, collected by an Internet survey. Details of the information stored in the purchase history information DB 15 will be described later. Information regarding the user is stored in the customer information DB 16. In the user-related information, for example, information such as the user's year of birth, gender, address, occupation, hometown, hobbies, and current family structure are stored. The data stored in the purchase history information DB 15 and the customer information DB 16 are associated with, for example, user identification information.

In addition, each or a plurality of functional components of the information processing device 1 shown in FIG. 3 may be achieved by processing by another device. For example, one information processing device 1 includes a learning control unit 11, a prediction control unit 12, a purchase history information DB 15, and a customer information DB 16, and another information processing device 1 includes a purchase prediction model 13, and both information processing. The device 1 may cooperate to perform the processing of the purchase prediction system 100.

Description of Data

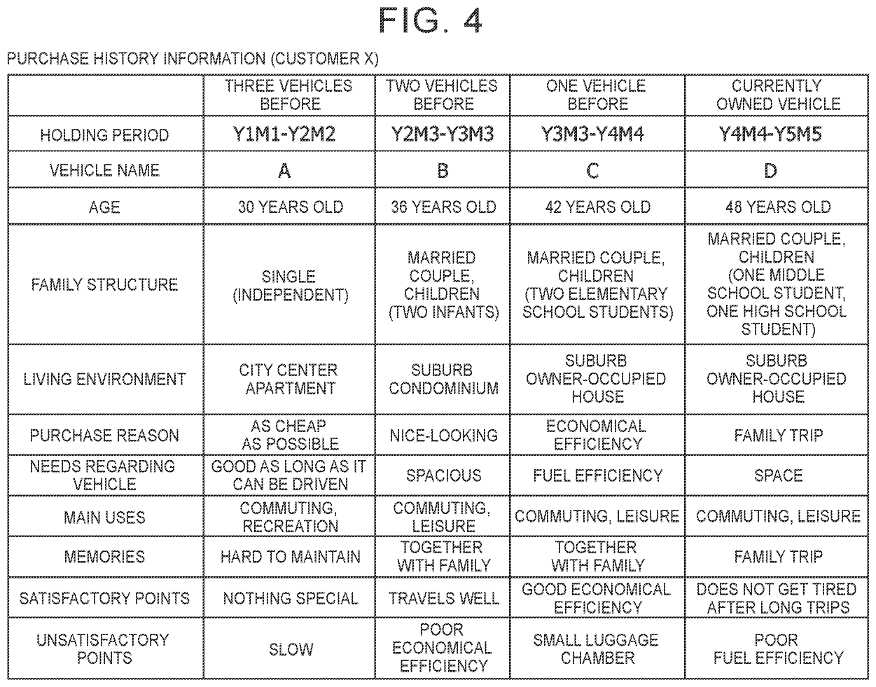

FIG. 4 is an example of the purchase history information. The purchase history information is information held in the customer information DB 16. In FIG. 4, the purchase history information of customer X is shown. The purchase history information is acquired, for example, by a questionnaire survey conducted on the Internet and in stores. In the first embodiment, the purchase history information includes, for each vehicle from the purchased vehicle three vehicles before to the currently owned vehicle, the holding period, the vehicle name, the age at the time of purchase, the family structure at the time of purchase, the living environment at the time of purchase, and the reason for purchase, the needs regarding the vehicle at the time of purchase, the main uses of the purchased vehicle, memories of the vehicle, and the satisfaction and dissatisfaction of the vehicle. For example, the purchase history information shown in FIG. 4 stores an option selected by the user from a plurality of options prepared as response data for each question in the questionnaire. In addition, when the purchase history of the user's vehicle is three vehicles or less, only the response data for the currently owned vehicle, the owned vehicle directly before the currently owned vehicle, and/or the vehicle owned two vehicles before is included. However, the purchase history information in which the purchase history of the vehicle is three vehicles or less may be excluded from the learning data or may be included in the learning data.

For example, among the examples shown in FIG. 4, for each vehicle, based on the living environment at the time of purchase, the reason for purchase, the needs regarding the vehicle at the time of purchase, the main uses of the vehicle, the memories of the vehicle, and the satisfaction and dissatisfaction of the vehicle, the user's value type regarding the purchase of each vehicle is acquired. This information is an example of “value information”. Further, among the examples shown in FIG. 4, the vehicle names of the purchased vehicle of three vehicles before to the currently owned vehicle are examples of “purchase history information”. The purchase history information is not limited to the information included in the example shown in FIG. 4. In addition, the currently owned vehicle can be said to be the last vehicle purchased. Further, for example, when the user does not currently own a vehicle, the response data regarding the “currently owned vehicle” is blank, and the “vehicle directly before” is the last purchased vehicle. In this case, “the vehicle two vehicles before”, “the vehicle three vehicles before”, and the like in the purchase history information are the vehicle directly before the last vehicle purchased, the vehicle two vehicles before, and the like.

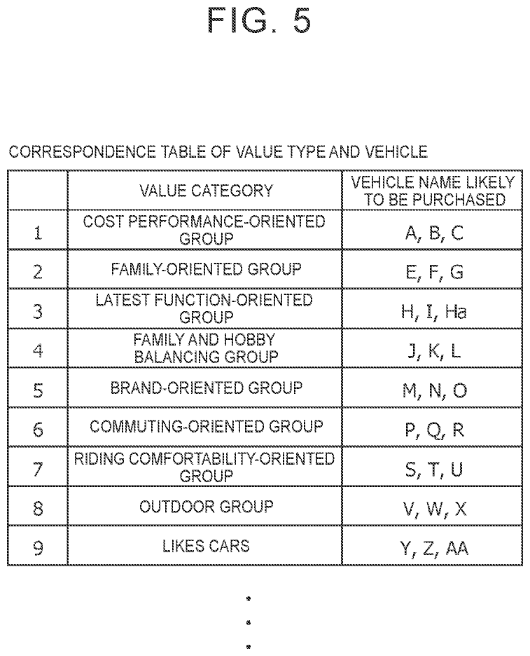

FIG. 5 is an example of the correspondence table 14 between the value type and the vehicle. In the correspondence table 14, the value type and the vehicle that is likely to be purchased by the user categorized into the value type are associated with each other. The value types shown in FIG. 5 include a cost performance-oriented group, a family-oriented group, a latest function-oriented group, and a brand-oriented group. The value types are predefined.

For example, for each vehicle shown in FIG. 4, the user at the time of purchase of the vehicle is categorized in any one value type shown in FIG. 5, by categorizing the following questionnaire response data in a predetermined categorizing method: the living environment at the time of purchase, the reason for purchase, the needs regarding the vehicle at the time of purchase, the main uses of the vehicle, the memories of the vehicle, the satisfaction and dissatisfaction of the vehicle. The definition of the value type is not limited to that shown in FIG. 5.

Learning and Prediction of Purchase Prediction Model

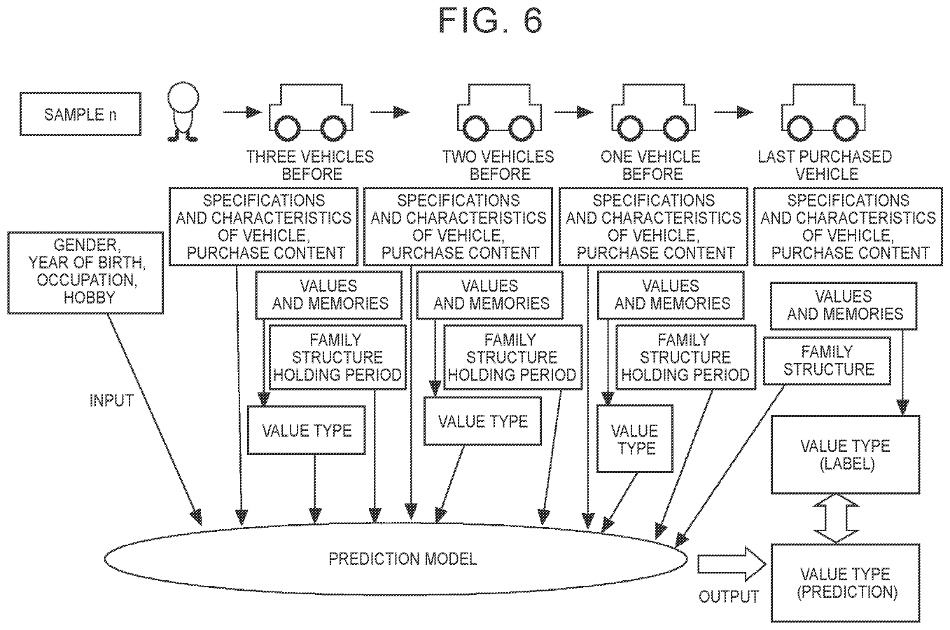

FIG. 6 is a diagram showing an example of learning in the purchase prediction model 13. When the learning control unit 11 receives the input of the instruction to start learning, the learning control unit 11 acquires the learning data. The learning data is data about a learning target user having a sample number n from the purchase history information DB 15 and the customer information DB 16. Specifically, the learning data is the user's attribute information and a set of the information regarding the vehicle, the response data of the questionnaire regarding the values and memories, the family structure at the time of purchase, and the holding period information, for each vehicle from the vehicle purchased three vehicles before the last purchased vehicle to the last purchased vehicle. Among the above information, the user attribute information is acquired from the customer information DB 16. For each vehicle from the vehicle purchased three vehicles before to the last purchased vehicle, the set of the information regarding the vehicle, the information regarding the values and memories, the family structure at the time of purchase, and the holding period information, is acquired from the purchase history information DB 15 (see FIG. 4).

First, the learning control unit 11 acquires the value type of the learning target user regarding the purchase, for each vehicle from the vehicle purchased three vehicles before the last purchased vehicle to the last purchased vehicle the last purchased vehicle of the learning target user. The value type is acquired by the category based on the response data of the questionnaire regarding the values and memories of the learning target user regarding each vehicle from the vehicle purchased three vehicles before the last purchased vehicle to the last purchased vehicle. the response data of the questionnaire regarding the values and memories used for categorizing the value type is the response data of the questionnaire of the living environment at the time of purchase, the reason for purchase, the needs regarding the vehicle at the time of purchase, the main uses of the vehicle, the memories of the vehicle, the satisfaction and dissatisfaction of the vehicle, for each vehicle of the example shown in FIG. 4.

For the categorization of value types, for example, any of the existing techniques such as a self-organizing map (SOM) and other cluster analysis methods may be used. For each vehicle from the vehicle purchased three vehicles before the last purchased vehicle to the last purchased vehicle the last purchased vehicle of the learning target user, by executing a predetermined categorization calculation process with the response data of the questionnaire regarding the values and memories serving as the input data, it is possible to acquire the value type regarding the purchase for each vehicle from the vehicle purchased three vehicles before the last purchased vehicle to the vehicle purchased directly before the last purchased vehicle.

The learning data of the purchase prediction model 13 sets as the input data, the attribute information of the user, the family structure at the time of purchase of the last purchased vehicle, and the set of the information regarding the vehicle, the value type, the family structure at the time of purchase, and the holding period information, for each vehicle from the purchased vehicle three vehicles before the last purchased vehicle to the vehicle purchased directly before the last purchased vehicle, of the learning target user. Further, the learning data of the purchase prediction model 13 is labeled with the value type of the purchase of the vehicle last purchased by the learning target user.

The attribute information of the learning target user is, for example, the year of birth, gender, occupation, hobby, and the like. However, the user attribute information used as the input data of the purchase prediction model 13 is not limited to these. The user attribute information used as the input data of the purchase prediction model 13 may be one or more of the year of birth, gender, occupation, and hobby, and other information is may be added or replaced with the above information.

The information regarding the vehicle is, for example, the vehicle name, specifications, characteristics, purchased content, and the like of the vehicle. The purchase history information DB 15 holds the vehicle name of the vehicle, but does not hold any other information. Information such as vehicle specifications and characteristics may be acquired by the learning control unit 11 by a predetermined database or a search on the Web based on the vehicle name of the vehicle. The purchased content of the vehicle is, for example, the content of the option selected by the user. The purchased content of the vehicle may be acquired by, for example, a questionnaire survey and stored in the purchase history information DB 15.

When a scored version of the above input data is input to the purchase prediction model 13, for example, the probability that the learning target user of all value types are categorized is acquired as output data. In contrast, the label is data in which the value type for the purchase of the last purchased vehicle in which the learning target user is categorized is 1, and the other value types are 0. The purchase prediction model 13 acquires the difference between the output data and the label, and adjusts the parameters so that the difference becomes small. In the purchase prediction model 13, the input of input data, the acquisition of the difference between the output data and the label, and the adjustment of the parameters are regarded as one learning for one learning data. The purchase prediction model 13 repeats the learning for the learning data having a sample number n until the predetermined number of times or the difference between the label and the output data becomes less than the threshold value. The sample number is, for example, 1000 to 10000.

Further, in the correspondence table 14 (see FIG. 5), for each value type, the vehicle that is likely to be purchased may be acquired from, for example, learning data. Specifically, for each value type, the higher-ranked vehicle purchased by the categorized learning target user and the vehicle having similar specifications and characteristics to the higher-ranked vehicle may be defined as a vehicle that is highly likely to be purchased, in the correspondence table 14. In the correspondence table 14, the definition of the vehicle that is highly likely to be purchased for each value type is not limited to this.

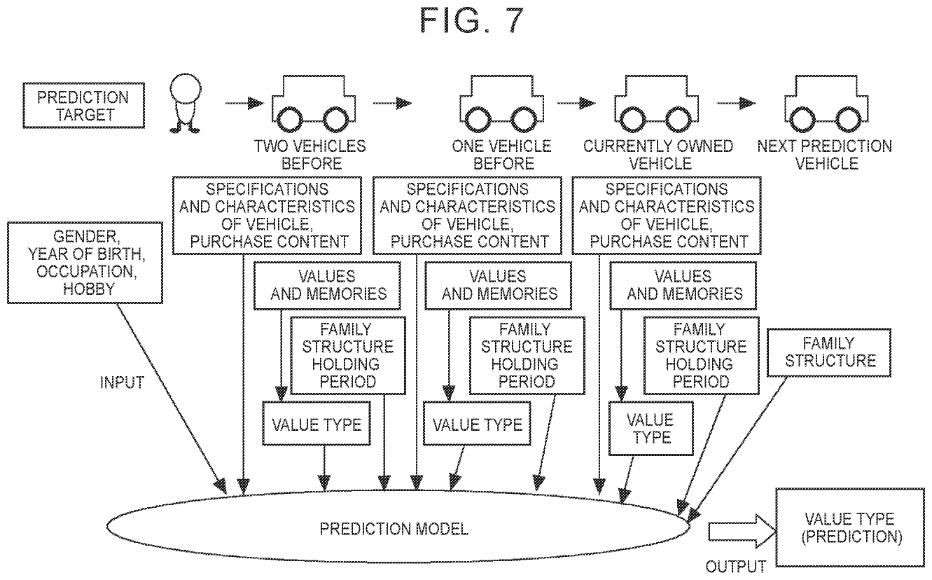

FIG. 7 is a diagram showing an example of the prediction process of the purchase prediction model 13. Upon receiving the input of the prediction start instruction, the prediction control unit 12 acquires the data of the prediction target user from the purchase history information DB 15 and the customer information DB 16. The prediction target user is specified together with the prediction start instruction. The data acquired at this time is the user's attribute information, the current family structure, and the set of the information regarding the vehicle, the response data of the questionnaire regarding the values and memories, the family structure at the time of purchase, and the holding period information, for each vehicle from the vehicle purchased two vehicles before to the currently owned vehicle. Among the above information, the user attribute information is acquired from the customer information DB 16. For the current family structure and each vehicle from the vehicle purchased two vehicles before to the currently owned vehicle, the set of the information regarding the vehicle, the information regarding the values and memories, the family structure at the time of purchase, and the holding period information, is acquired from the purchase history information DB 15 (see FIG. 4).

First, the prediction control unit 12 acquires the value type each vehicle from the vehicle purchased two vehicles before to the currently owned vehicle, based on the response data of the questionnaire regarding the values and memories. The categorizing method of value type is the same as during learning.

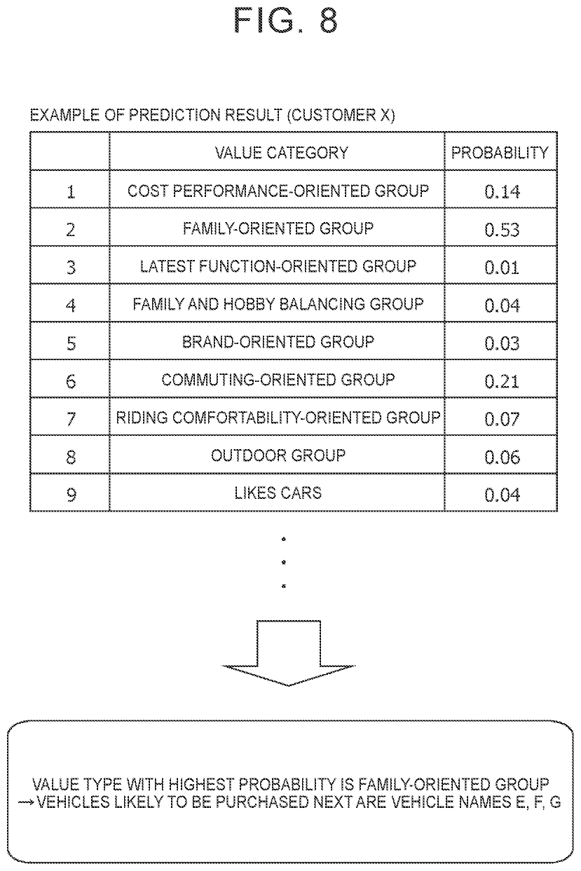

The prediction control unit 12 sets as the input data, the user's attribute information, the current family structure, and the set of the information regarding the vehicle, the value type, the family structure at the time of purchase, and the holding period information, for each vehicle from the vehicle purchased two vehicles before to the currently owned vehicle, of the prediction target user. The prediction control unit 12 inputs the scored input data to the purchase prediction model 13 and acquires the output data. Details of the output data will be described in FIG. 8 below.

FIG. 8 is a diagram showing an example of a determination process of a purchased product based on output data of the purchase prediction model 13. As the output data (prediction result) of the purchase prediction model 13, the probability that the current values of the prediction target user are categorized is acquired for each value type. The prediction control unit 12 determines the value type with the highest probability as the current value type of the prediction target user, and determines the vehicle associated with the value type in correspondence table 14 as the vehicle that the prediction target user may purchase next (see FIG. 5).

In the example shown in FIG. 8, the probability of a value type 2 “family-oriented group” is the highest, and the prediction control unit 12 determines that vehicles E, F, G that have the vehicle name associated with the value type 2 “family-oriented group” in the correspondence table 14 are the vehicles that the prediction target user may purchase next. The prediction control unit 12 outputs information regarding the vehicle that the prediction target user may purchase next. The information regarding the vehicle that may be purchased next is, for example, information such as the vehicle name, specifications, and characteristics.

The prediction control unit 12 may determine that the vehicle associated with the high ranking predetermined number of value types in which the probability that the current values of the prediction target user is high is the vehicle that the prediction target user may purchase next, and may output the information regarding the vehicles.

In the above-mentioned learning and prediction process, a part of the input and the output data of the purchase prediction model 13 are used as the category probability of the value type. However, the present disclosure is not limited to this. There are thousands of types of vehicles in the world, and the number is enormous. In addition, each user has different values, and the number of combinations of questionnaire response data is enormous. By categorizing the user's values into the predetermined number of types and associating the vehicles that are likely to be purchased with each type, the amount the input data and output data of the purchase prediction model 13 can be scaled down, and a processing load by the purchase prediction model 13 can be reduced.

In contrast, when the performance of the information processing device 1 is sufficient, in the input data and the output data of the purchase prediction model 13, the questionnaire response data may be used as it is as a part of the input data and the output data may be used as the purchase probability for each vehicle, without using the value type.

Further, the input data of the purchase prediction model 13 is not limited to the above-mentioned input data. Among the above-mentioned input data, the input data of the purchase prediction model 13 may include as an option, each of the following: the attribute information of the user; the current family structure; and the value type, the family structure at the time of purchase, and the holding period information, for each vehicle from the vehicle purchased three vehicles before to the vehicle purchased directly before or from the vehicle purchased two vehicles before to the currently owned vehicle. Further, the input data of the purchase prediction model 13 may include information regarding the user's original experience in addition to the above-mentioned input data. Information regarding the user's original experience includes, for example, the family structure during childhood, hometown, and hobbies during childhood.

### Processing Flow

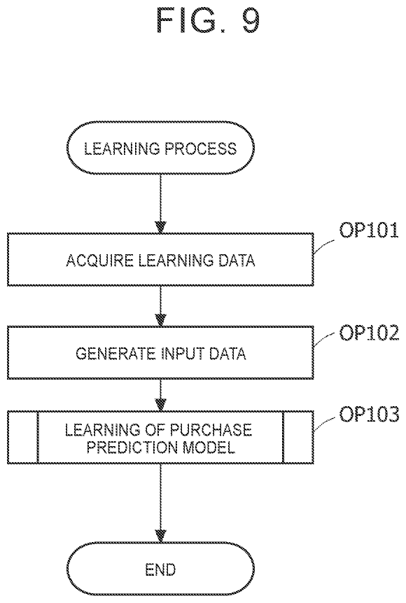

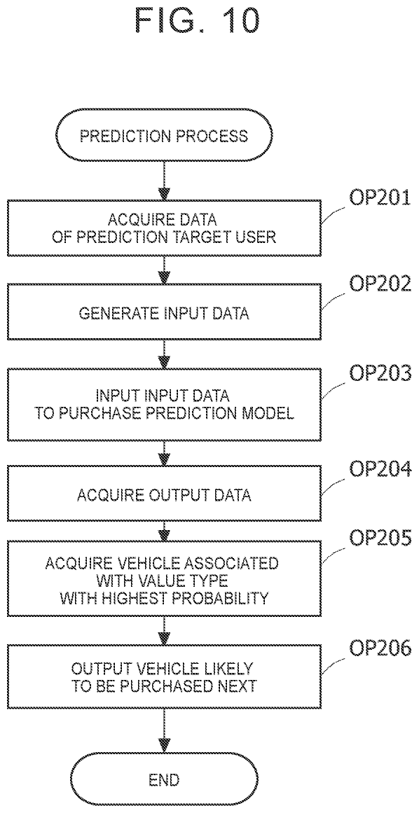

FIG. 9 is an example of a flowchart of a learning process of the purchase prediction model 13 in the purchase prediction system 100. The process shown in FIG. 9 is, for example, executed by inputting an instruction to start learning or executed at a predetermined cycle. The main body of execution of the process of the information processing device 1 shown in FIG. 9 is the CPU 101 of the information processing device 1. However, for convenience, the functional components will be described as the main body. The same applies to FIG. 10.

In OP101, the learning control unit 11 acquires the learning data of the sample number n of the purchase prediction model 13 from the purchase history information DB 15 and the customer information DB 16. In OP102, for each purchase from the vehicle purchased three vehicles before the last purchased vehicle to the last purchased vehicle of each learning data, the value type is acquired from the acquired learning data, and the input data to the purchase prediction model 13 is generated (see FIG. 4 to FIG. 6). In OP103, the learning control unit 11 inputs the generated input data and the label into the purchase prediction model 13 for learning. The purchase prediction model 13 repeatedly learns each of the learning data of the sample number n for a predetermined number of times or until the output of the output data and the label becomes less than a threshold value. When the learning of the purchase prediction model 13 is completed, the process shown in FIG. 9 is completed.

FIG. 10 is an example of a flowchart of the prediction process in the purchase prediction system 100. The process shown in FIG. 10 is, for example, executed by inputting an instruction to start prediction or executed at a predetermined cycle.

In OP201, the prediction control unit 12 acquires the data of the designated prediction target user from the purchase history information DB 15 and the customer information DB 16. In OP202, for each purchase from the vehicle purchased two vehicles before to currently owned vehicle, the prediction control unit 12 acquires the value type of the prediction target user from the prediction target user data, and generates the input data to the purchase prediction model 13.

In OP203, the prediction control unit 12 inputs the generated input data to the purchase prediction model 13. In OP204, the prediction control unit 12 acquires the probability that the prediction target user is categorized into each value type as the output data of the purchase prediction model 13. In OP205, the prediction control unit 12 acquires the vehicle associated with the value type having the highest probability in the correspondence table 14 as the vehicle that the prediction target user is likely to purchase next. In OP206, the prediction control unit 12 outputs information regarding the vehicle that the prediction target user is likely to purchase next. After that, the process shown in FIG. 10 ends.

The processes shown in FIG. 9 and FIG. 10 are examples, and the execution order can be changed, the processes can be changed, and the like, depending on the embodiment.

### Action Effect of First Embodiment

In the first embodiment, based on the information in which the values of the prediction target user regarding purchasing the product are reflected such as the purchase history information of the product of the prediction target user, the response data of the questionnaire, the family structure, and the user attributes, the next product that the prediction target user may purchase is predicted. As a result, it is possible more accurately predict the product that the prediction target user is likely to purchase, in consideration of the user's original unchangeable values and the values that change with the passage of time and changes in the environment. The product that the prediction target user may purchase next can be used for sales promotion such as proposing the product to the prediction target user and for product development.

### Other Embodiments

The above-described embodiment is merely an example, and the present disclosure may be appropriately modified and implemented without departing from the scope thereof.

In the first embodiment, the description is made on the premise that the number of vehicles owned by the user at the same time is one. However, the same can be applied even when a plurality of vehicles are owned at the same time. For example, when purchasing a vehicle, it is sufficient to determine from the vehicle purchased three vehicle before to the currently owned vehicle. The purchase time of the vehicle is, for example, the start time of the holding period of the vehicle.

In the first embodiment, the vehicle name of the vehicle that the prediction target user may purchase next is predicted. However, the vehicle name is not limited to this, and the granularity of the predicted vehicle can be arbitrarily set. For example, from the output of the purchase prediction model 13, the vehicle name and grade of the vehicle that the prediction target user may purchase next may be predicted. For example, it can be realized by setting the vehicle corresponding to the value type in the correspondence table 14 to the vehicle name and grade.

The processes and means described in the present disclosure can be freely combined and implemented as long as no technical contradiction occurs.

Further, the processes described as being executed by one device may be shared and executed by a plurality of devices. Alternatively, the processes described as being executed by different devices may be executed by one device. In the computer system, it is possible to flexibly change the hardware configuration (server configuration) for realizing each function.

The present disclosure can also be implemented by supplying a computer with a computer program that implements the functions described in the above embodiments, and causing one or more processors of the computer to read and execute the program. Such a computer program may be provided to the computer by a non-transitory computer-readable storage medium connectable to the system bus of the computer, or may be provided to the computer via a network. The non-transitory computer-readable storage medium is, for example, a disc of any type such as a magnetic disc (floppy (registered trademark) disc, hard disk drive (HDD), etc.), an optical disc (compact disc read-only memory (CD-ROM), digital versatile disc (DVD), Blu-ray disc, etc.), a read only memory (ROM), a random access memory (RAM), an erasable programmable read only memory (EPROM), an electrically erasable programmable read only memory (EEPROM), a magnetic card, a flash memory, an optical card, and any type of medium suitable for storing electronic commands.

What is claimed is:

1. An information processing method comprising:
inputting purchase history information of a second user to a prediction model, the second user being a prediction target, the prediction model having learned with learning data,
the learning data including purchase history information of a first user as input data and information regarding a first product as a label, the first user being a learning target, the first product being last purchased by the first user, the learning data being learning data regarding a plurality of the first users, the purchase history information of the first user including information regarding each of N (N: a positive integer of 2 or more) second products from a product purchased directly preceding the first product to a product purchased N products before the first product, and the purchase history information of the second user including information regarding each of N third products including purchased products from a product currently owned by the second user to a product purchased N−1 products before the product that is currently owned;
acquiring first information regarding one or a plurality of products having a possibility to be purchased by the second user, based on an output from the prediction model in response to the input; and
outputting the first information.

2. The information processing method according to claim 1, wherein:
the input data of the learning data further includes a family structure of the first user at a time of purchase of the first product; and
in the input to the prediction model, a current family structure of the second user is further input.

3. The information processing method according to claim 2, wherein:
the input data of the learning data further includes the family structure of the first user at a time of purchase of each of the N second products; and
in the input to the prediction model, the family structure of the second user at a time of purchase of each of the N third products is further input.

4. The information processing method according to claim 1, wherein:
the input data of the learning data further includes a holding period of each of the N second products; and
in the input to the prediction model, a holding period of each of the N third products is further input.

5. The information processing method according to claim 1, wherein:
the input data of the learning data further includes an attribute of the first user; and
in the input to the prediction model, an attribute of the second user is further input.

6. The information processing method according to claim 1, wherein:
the input data of the learning data further includes N pieces of value information of the first user indicating values regarding purchase, regarding each of the N second products; and
in the input to the prediction model, N pieces of value information of the second user regarding each of the N third products are further input.

7. The information processing method according to claim 6, wherein the value information of the first user and the value information of the second user are response data of a questionnaire of the first user and the second user on values regarding purchasing the product, respectively.

8. The information processing method according to claim 7,
further comprising storing, in a storage unit, an association of each of a predetermined number of types that categorize the values of a user regarding purchasing the product, and one or a plurality of products that the user is likely to purchase and that are categorized to each of the predetermined number of types, wherein:
the N pieces of value information of the first user are N types of the first user that are categorized based on the response data of the questionnaire of the first user regarding each of the N second products;
the label of the learning data is a type of the first user that is categorized based on the response data of the questionnaire of the first user regarding purchasing the first product serving as information regarding the first product;
N types of the second user that are categorized based on the response data of the questionnaire of the second user regarding each of the N third products are required as the N pieces of value information of the second user;
the N types of the second user regarding each of the N third products are further input to the prediction model;
based on the output with respect to the input to the prediction model, a first type into which current values of the second user regarding purchasing the product is predicted to be categorized is acquired; and
in the storage unit, information regarding one or more products associated with the first type is acquired as the first information.

9. The information processing method according to claim 8, wherein:
an output of the prediction model is a probability that the current values of the second user regarding purchasing the product are categorized, for each of the predetermined number of types; and
a type having a highest probability is acquired as the first type.

10. The information processing method according to claim 1, wherein the prediction model learns with the learning data.

11. An information processing device comprising a control unit that executes:
input of purchase history information of a second user to a prediction model, the second user being a prediction target, the prediction model having learned with learning data, the learning data including purchase history information of a first user as input data and information regarding a first product as a label, the first user being a learning target, the first product being last purchased by the first user, the learning data being learning data regarding a plurality of the first users, the purchase history information of the first user including information regarding each of N (N: a positive integer of 2 or more) second products from a product purchased directly preceding the first product to a product purchased N products before the first product, and the purchase history information of the second user including information regarding each of N third products including purchased products from a product currently owned by the second user to a product purchased N−1 products before the product that is currently owned;
acquisition of first information regarding one or a plurality of products having a possibility to be purchased by the second user, based on an output from the prediction model in response to the input; and
output of the first information.

12. The information processing device according to claim 11, wherein:
the input data of the learning data further includes a family structure of the first user at a time of purchase of the first product; and
in the input to the prediction model, a current family structure of the second user is further input by the control unit.

13. The information processing device according to claim 12, wherein:
the input data of the learning data further includes the family structure of the first user at the time of purchase of each of the N second products; and
in the input to the prediction model, the family structure of the second user at the time of purchase of each of the N third products is further input by the control unit.

14. The information processing device according to claim 11, wherein:
the input data of the learning data further includes a holding period of each of the N second products; and
in the input to the prediction model, a holding period of each of the N third products is further input by the control unit.

15. The information processing device according to claim 11, wherein:
the input data of the learning data further includes an attribute of the first user; and
in the input to the prediction model, an attribute of the second user is further input by the control unit.

16. The information processing device according to claim 11, wherein:
the input data of the learning data further includes N pieces of value information of the first user indicating values regarding purchase, regarding each of the N second products; and
in the input to the prediction model, the N pieces of value information of the second user regarding each of the N third products is further input by the control unit.

17. The information processing device according to claim 16, wherein the value information of the first user and the value information of the second user are response data of a questionnaire of the first user and the second user on values regarding purchasing the product, respectively.

18. The information processing device according to claim 17,
further comprising a storage unit that stores an association of each of a predetermined number of types that categorize the values of the user regarding purchasing the product, and one or a plurality of products that the user is likely to purchase and that are categorized to each of the predetermined number of types, wherein:
the N pieces of value information of the first user are N types of the first user that are categorized based on the response data of the questionnaire of the first user regarding each of the N second products;
the label of the learning data is a type of the first user that is categorized based on the response data of the questionnaire of the first user regarding purchasing the first product serving as information regarding the first product;
the control unit acquires N types of the second user that are categorized based on the response data of the questionnaire of the second user regarding each of the N third products as the N pieces of value information of the second user;
the control unit further inputs the N types of the second user regarding each of the N third products to the prediction model;
the control unit acquires a first type into which current values of the second user regarding purchasing the product is predicted to be categorized, based on the output with respect to the input to the prediction model; and
the control unit acquires information regarding one or a plurality of products associated with the first type in the storage unit as the first information.

19. The information processing device according to claim 18, wherein:
an output of the prediction model is a probability that the current values of the second user regarding purchasing the product are categorized, for each of the predetermined number of types; and
the control unit acquires a type having a highest probability as the first type.

20. A program for causing a computer to execute the information processing method according to claim 1.
